(19) United States
(12) Patent Application Publication
(10) Pub. No.: US 2005/0282437 A1
(43) Pub. Date: Dec. 22, 2005

(54) Electrical connector assembly

(75) Inventor: Chia-Hao Fan, Tu-Chen (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/114,299

(22) Filed: Apr. 25, 2005

(30) Foreign Application Priority Data
Jun. 18, 2004 (TW) 093117597

(51) Int. Cl. H01R 13/648

(52) U.S. Cl. 439/608

(57) ABSTRACT

An electrical connector (1) consists of a receptacle connector (2) and a plug connector (3) to be connected to the receptacle connector (2). The receptacle connector (2) comprises a first insulating case (4), a plurality of first electrical contacts (23) received in said first insulating case (4), a pair of first shielding covers (22) provided on opposite sides of said first insulating case (4) and a pair of shutter members (21) set onto said first insulating case (4). Otherwise, the shutter member (21) comprises a sliding piece (211) extending downwardly from the one edge thereof, which slides on a contact piece (223) curving upwards from the upper edge of the first shielding cover (22), which not only preclude discharge of static electricity but also prevent the shutter members from suffering destruction. The plug connector (3) consists of a second insulating case (6), a guide device (63) at least provided on one end of the second insulating case (6) and a pair of second shielding covers (31), of which a plurality of second grounding pieces (311) extend downwardly from the low edges.

### BACKGROUND OF THE INVENTION

1. Field of the Invention

The present invention relates to an electrical connector assembly, more particular, to an electrical connector assembly that has means for preventing dust and dirt from entering into it. The instant application relates to the copending applications titled “ELECTRICAL CONNECTOR” and “ELECTRICAL CONNECTOR ASSEMBLY” respectively claiming priorities of the Taiwan applications 93117596 and 93716043, and having the same applicant and the same assignee with the instant application.

2. Description of Related Art

In order to achieve power or signal transmission, various kinds of electrical connectors are generally used to connect internal components within electrical devices and connect an electrical device with other devices. However, in untidy condition, especially when electrical connectors are not fitted, dust and dirt may enter into the electrical connector to adversely effect against power or signal transmission.

At present, in order to solve the above-mentioned question, a pair of shutter members is designed on a plug fitting section of a connector. When the connector is brought close to a mating connector, a guide member provided on the mating connector opens the shutter member to achieve connection. However, when the connector is connected to the mating connector, static electricity produced on the connector and the mating connector will be discharged to adversely affect the signal transmission therebetween. Therefore, the static electricity is required to be discharged before the connection between electrical contacts. U.S. patent application Pub. No. 2002/0177336 discloses an electrical connector with a shutter member, which solves the above problem about the discharge of static electricity.

The shutter member comprises a metallic wire provided along an edge thereof and a coil spring positioned between the shutter member and a shield shell provided on the connector. One end portion of the coil spring is electrically connected with the metallic wire and the other end portion of the spring is electrically connected with the shield shell of the connector. On the other hand, a conductive wire is fitted within a narrow groove formed on an actuator of a mating connector. When the connectors come to be connection, the metallic wire of the connector electrically connects the conductive wire of the mating connector before connection of the electrical contacts of the connectors due to peaks of actuator of the mating connector extending beyond a mating face of the mating connector. The static electricity is precluded by the metallic wire, the conductive wire, the coil spring and the shield shell at an early step in the mating engagement process. However, the coil spring is continuously elongated, as a result, it is possible that the electrical connection between the coil spring and the metallic wire is interrupted. Furthermore, when the second connector is plugged out of the electrical connector, the elastic force of the coil spring is too big so that the shutter member bumps to suffer destruction.

Therefore, it is desirable to provide an electrical connector to overcome the above problems.

### SUMMARY OF THE INVENTION

The object of the present invention is to provide an electrical connector assembly having an electrical connector and a receptacle connector, on which static electricity can be discharged before connection between contacts.

Another object of the present invention is to provide an electrical connector with a shutter member, which can prevent the shutter member from destroying.

In order to achieve the object set forth, the electrical connector assembly according to the present invention comprises a receptacle connector and a plug connector to be connected to the receptacle connector. The receptacle connector comprises a first insulating case, a plurality of first electrical contacts received in the first insulating case, a pair of first shielding covers provided on opposite sides of the first insulating case and a shutter member mounted onto the first insulating case. Otherwise, the shutter member comprises a sliding piece extending downwardly from the one edge thereof, which slides on a contact piece curving upwards from an upper edge of the first shielding cover. The sliding pieces slide on the contact pieces to not only preclude static electricity but also prevent the shutter member from destruction. The plug connector comprises a second insulating case, a guide device provided on one end of the second insulating case and a pair of second shielding covers, of which a plurality of second grounding pieces extend downwardly from the low edges.

The detailed features of the present invention will be apparent in the detailed description with appropriate reference to the accompanying drawings.

### BRIEF DESCRIPTION OF THE DRAWINGS

FIG. 1 is a perspective view of an electrical connector assembly according to the present invention before connection;

FIG. 2 is an exploded perspective view of a receptacle connector of the electrical connector assembly in FIG. 1;

FIG. 3 is an exploded perspective view of a plug connector of the electrical connector assembly in FIG. 1;

FIG. 4 is a partially enlarged perspective view of the receptacle connector in FIG. 2, but taken from another aspect;

FIG. 5 is a partially enlarged perspective view of the plug connector in FIG. 3, but taken from another aspect;

FIG. 6 is a perspective view of the electrical connector assembly showing the plug connector not completely mating with the receptacle connector;

FIG. 7 is a planar view showing guide pins of the plug connector partially entering a shutter member of the receptacle connector;

FIG. 8 is a view similar to FIG. 7 showing the guide pins of the plug connector completely entering the shutter member of the receptacle connector; and

FIG. 9 is a view similar to FIG. 6 showing the plug connector completely mating with the receptacle connector.

### DETAILED DESCRIPTION OF THE INVENTION

The present invention is now described in detail.

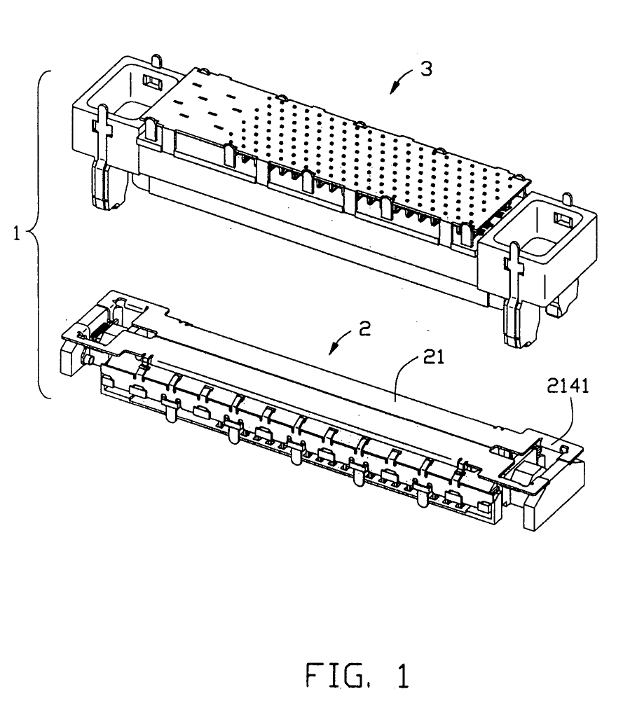

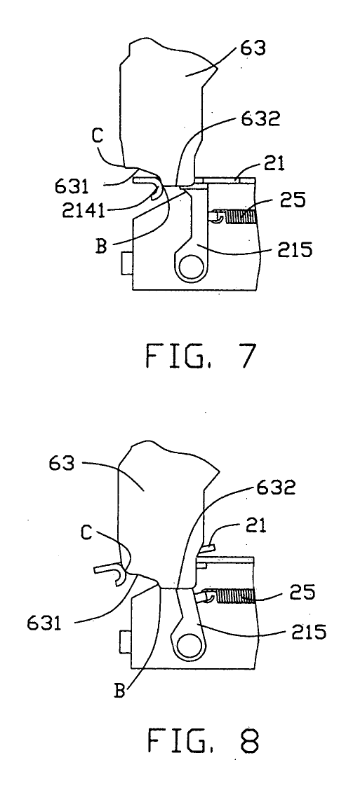

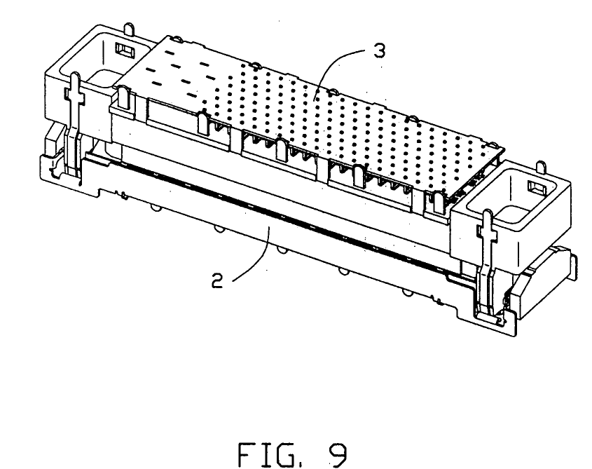

In FIGS. 1-9, an electrical connector assembly 1 according to the present invention comprises a receptacle connector 2 and a plug connector 3 to be connected to the receptacle connector 2. As shown in FIG. 1, the receptacle connector 2 provides a shutter member 21 in order to prevent dust and dirt from entering into the receptacle connector 2.

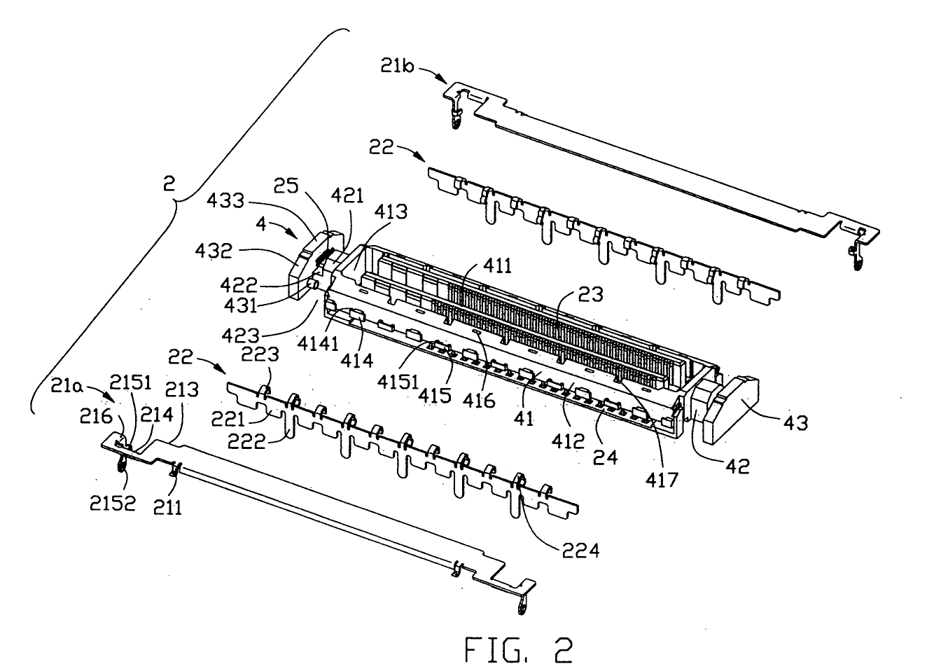

As shown in FIGS. 2 and 4, the receptacle connector 2 comprises a first insulating unitary elongate case 4, a pair of first shielding covers 22 mounted on the outer periphery of the first insulating case 4 and a shutter member 21. The first insulating case 4 comprises a first base portion 41, a pair of neck portions 42 extending from opposite ends of the first base portion 41 and a pair of wall portions 43 extending from the pair of neck portions 42. The first base portion 41 is provided with a first bottom board 24 mounted thereon and has a groove along the longitudinal direction of the insulating case 4. The groove has a pair of side walls 412 at opposite sides thereof and a pair of plug fitting section 411 protrude into the groove accommodating a plurality of first electrical contacts 23 at opposite sides thereof. Two separate through-holes 413 are provided at opposite ends of the groove. The plurality of first electrical contacts 23 extends downwards through the first bottom board 24 to connect with a printed circuit board. A plurality of first convexities 414 and a plurality of second convexities 415 are alternatly arranged at intervals along an outer periphery of the pair of side walls 412. The first convexties 414 further comprise blocks 4141 and the second convexities 514 further comprise slots 4154. A gap 416 and a passage 417 are provided on an upper surface of the side walls 412 at intervals along the longitudinal direction. In addition, a top of the neck portion 42 is flanked by a pair of slanted first guide faces 421. A spring 25 is provided in a concave 422 defined between the neck portion 42 and the wall portion 43 and connected with the shutter member 21 to elastically drive the shutter member 21 to close the plug fitting section 411 of the insulating case 4. The wall portion 43 is a board perpendicular to the longitudinal direction. For a width of the neck portion 42 perpendicular to the longitudinal direction is smaller than a corresponding width of the first base portion 41, there is a receiving space 423 defined between the first base portion 41 and the wall portion 43 and adjacent to the neck portion 42. A pair of sliding faces 432 respectively extends downwards from the top of the wall portion 43. Otherwise, a step portion 433 is formed on the top of the sliding face 432 and symmetrically arranged about the central line of the shutter member 21. Two shafts 431 are provided on the wall portion 43 to extend into the receiving space 423 so as to mount the shutter member 21.

Then, referring to FIGS. 2 and 4, the pair of first shielding covers 22 is formed and stamped from a metal sheet and configured in an elongated shape. Each of the first shielding covers 22 comprises a plurality of fixing pieces 221 and a plurality of first grounding pieces 222 extending downwards from a lower edge thereof arranging at intervals, a plurality of contact pieces 223 and elastic contact pieces 224 curving upwards from an upper edge thereof at intervals. When the pair of first shielding covers 22 are mounted on the first base portion 41, the fixing pieces 221 are inserted into a space between the first convexities 414 and the second convexities 415 and are secured by the blocks 4141. At the same time, the first grounding pieces 222 are inserted into the slots 4151 and extend downward to connect with the grounding wire of a printed circuit board, also, the contact pieces 223 are fixed into the gap 416 and the forepart of the elastic contact pieces 224 are received into the passage 417.

The shutter member 21 is mounted to the insulating case and movable with respect to the insulating case to open and close the plug fitting section of the insulating case and the shutter member comprises a pair of shutter member halves 21a, 21b of metal. As the halves 21a, 21b are substantially symmetrical, a description will be given of the first half 21a with the understanding that the second half 21b is of substantially similar configuration. The first half 21a comprises a base section. Two separate openings 214 are provided on opposite ends of the base section of the first half 21a and two smaller openings 213 are adjacent to the openings 214. For the two separate openings 214 are the same, one opening 214 is described. A guide piece 2141 curves downwards from one side to the opening of the opening 214 (as shown in FIG. 1). A mating arm 215 is extending downwardly from a distal end 216 which is perpendicular to a surface of the base section of the first half 21a. Further, a locking portion 2151 protrudes from an edge of the mating arm 215 to the guide piece 2141 and a pivot hole 2152 is provided in free end of the mating arm 215. Otherwise, sliding pieces 211 extend downwardly from one edge of the base section of the first half 21a. Specially, the opening direction of the openings 214, 213 is different from the protruding direction of the sliding pieces 211. As shown in FIG. 1, when the pivot hole 2152 of the first half 21a is secured on the shaft 431 of the first insulating case 4, the spring 25 is secured with the responding locking portion 2151. Under certain force, the shutter member 21 is able to close and open the plug fitting section 411 of the receptacle connector 2. When the shutter member 21 is closed, the opening formed by the two smaller openings 213 of the shutter member halves 21a, 21b communicates with the through-hole 413, the opening formed by the two openings 214 of the shutter member halves 21a, 21b communicates with the receiving space 423. Simultaneously, the distal ends 216 abut against the step portions 433 and the sliding pieces 211 meet the contact pieces 223 of the first shielding covers 22. As a result, dust and dirt can not enter into the plug fitting section 411 to contaminate the first electrical contacts 23. On the other hand, while the shutter members 21 open the plug fitting section 411, the sliding pieces 211 are sliding along the contact pieces 223.

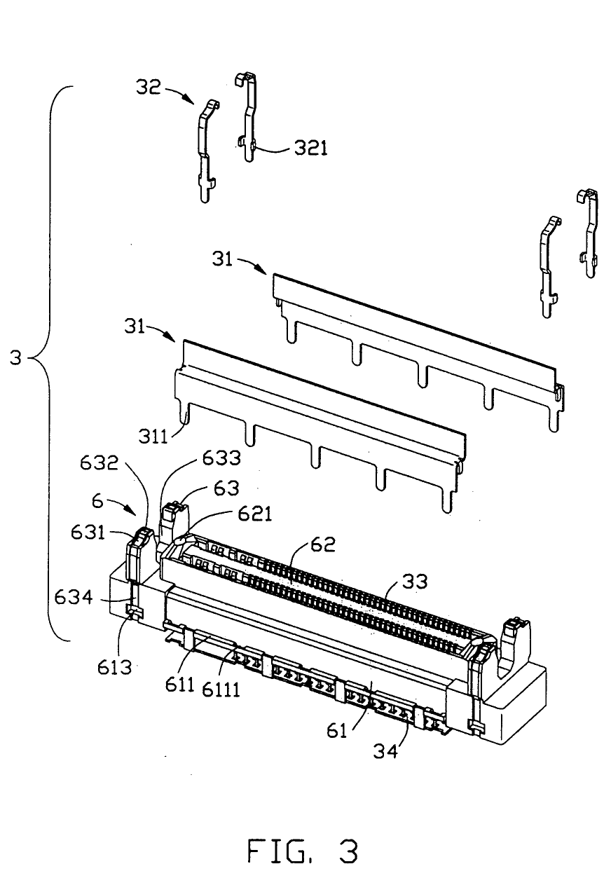

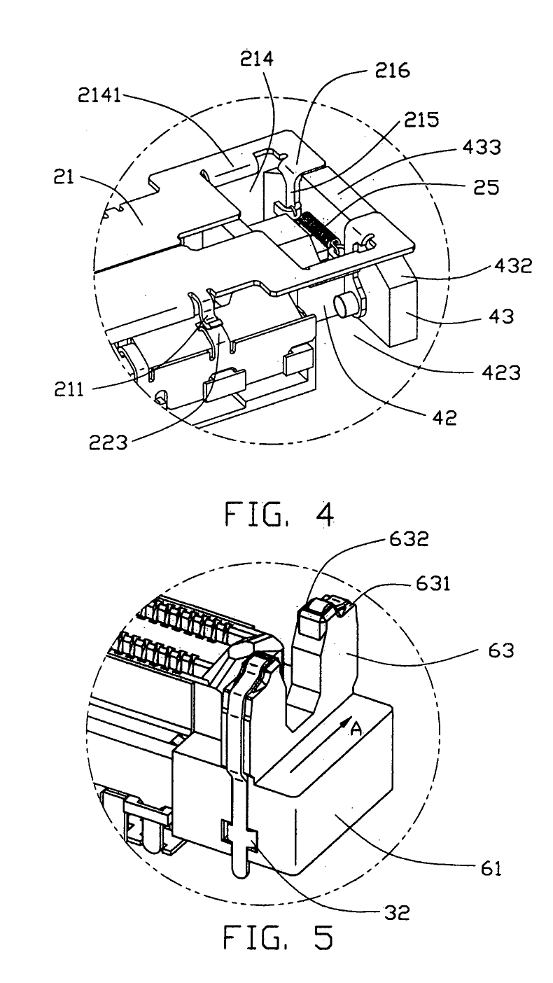

Then, referring to FIG. 3, the plug connector 3 consists of a second insulating unitary elongate case 6, a pair of second shielding covers 31 mounted on an outer periphery of the second insulating case 6 and grounding contacts 32. The second insulating case 6 comprise a second base portion 61, a receptacle fitting section 62 extending upwardly from the second base portion 61 and a pair of separate guide devices 63. A plurality of slots 6111 is located on a pair of ribs 611 extruding from opposite sides of the second base portion 61. The receptacle fitting section 62 is provided with a second bottom board 34 mounted thereon and has a groove along the longitudinal direction. The receptacle fitting section 62 protrudes into the groove accommodating a plurality of second electrical contacts 33 at two sides thereof. The plurality of second electrical contacts 33 extends downwardly through the second base portion 61 and the second bottom board 34 to connect with a printed circuit board. Furthermore, a pair of separate guide tapers 621 extends upwardly from opposite ends of the receptacle fitting section 62 to connect with the plug fitting section 411 of the receptacle connector 2. In addition, the guide devices 63 extended from the second base portion 61 are adjacent to the guide tapers 621 at the same direction of the receptacle fitting section 62 and the guide tapers 621. On the other hand, a plurality of second grounding pieces 311 extends downwards from the low edge of the second shielding covers 31 and is inserted into the slots 6111 of ribs 611 of the second base portion 61 so as to connect to the ground.

As shown in FIGS. 3 and 5, the guide devices 63 is of a saddle shape and engageable with the neck portion 42 upon extending through the opening 214 into the receiving space 423 to drive the shutter member 21 open the plug fitting section 411. Each of the guide devices 63 has a pair of guide columns. The guide columns extend perpendicularly to the direction of the arrow A and arranges symmetrically at a distance. Because the pair of guide columns is the same structure, so one of the guide columns is described. The guide column comprises a peak 632, a slanted second guide face 631, a long groove 634 and an inner surface 633. The second guide face 631 is located in flank of the guide column and slopes up to form the peak 632. Furthermore, the long groove 634 extends from the peak 632 to a bottom of the second base portion 61 and a longitudinal securing portion 613 of the second base portion 61 is provided on the free end of the long groove 634 and the width of which is more than that of the long groove 634. Both the peak 632 and the second guide face 631 are located in the long groove 634. When the grounding contact 32 of metal material is fitted on the second base portion 61, the grounding contact 32 is secured in the long groove 634 and a bender 321 is provided at the free end of the grounding contact 32 and is secured in the longitudinal securing portion 613 of the second base portion 61. On the other hand, the inner surface 633 of the guide column matches with the surface of the neck portion 42 of the first insulating case 4.

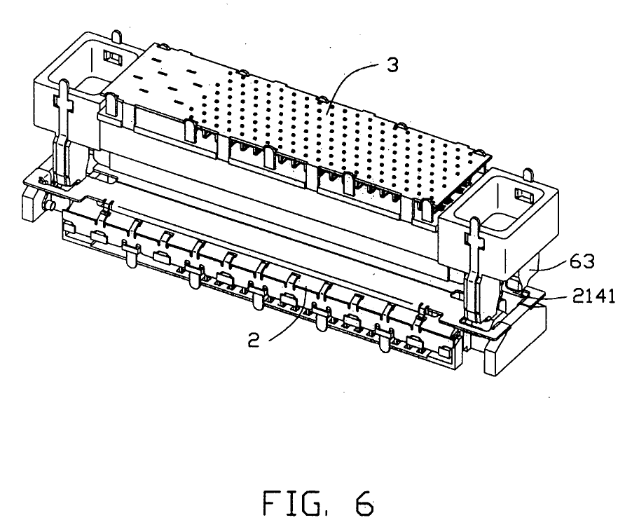

Referring to FIGS. 6-9, when the plug connector 3 is plugged into the receptacle connector 2, firstly, the peak 623 of the guide device 63 enters into the opening 214 and contacts the guide piece 2141 at the point of B. At the moment, static electricity of the plug connector 3 and the receptacle connector 2 is released through the grounding contact 32, the guide piece 2141, the sliding piece 211 and the contact piece 223 of the first shielding cover 22. However, in this moment the receptacle fitting section 62 does not contact with the plug fitting section 411 and the second electrical contacts 33 also does not contact with the first electrical contacts 23. Secondly, the second guide face 631 of the guide device 63 slides on the guide piece 2141 to the point of C to drive the mating arm 215 to rotate about the shaft 431 and the spring 25 is elongated at the same time. Meanwhile, the sliding piece 211 slides on the contact piece 223 so that the receptacle fitting section 62 is entirely connected to the plug fitting section 411. Especially, when the guide column of the guide device 63 moves to the point of C, the transverse width of the guide column accelerates so as to open the shutter members 21 rapidly. To disconnect the plug fitting section 411 from the receptacle fitting section 62, the receptacle connector 2 is disconnected from the plug connector 3. That is to say, when the plug connector 3 is lifted up from the receptacle connector 2, the guide pins 63 come out of the receiving space 423 and the shutter member 21 is closed to be drove by the spring 25. Especially, the step portions 433 can prevent the shutter sheet 21a from coming into collision with the shutter sheet 21b and resulting in suffering destruction as a result of release of the spring 25. Otherwise, the sliding pieces 211 can cushion the collision between the shutter sheets 21a, 21b for sliding on the contact pieces 223.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrical connector assembly comprising:
a receptacle connector comprising:
a first insulating case comprising a first base portion having a plug fitting section;
a plurality of first electrical contacts received in the plug fitting section of the first insulating case;
a first shielding cover provided on opposite sides of the first insulating case and formed with a plurality of contact pieces;
a shutter member mounted on the first insulating case and movably opening and closing the plug fitting section of the first insulating case, the shutter member comprising a sliding piece electrically and mechanically connecting with the contact pieces of the first shielding cover; and
a plug connector comprising:
a second insulating case comprising a second base portion and a receptacle fitting section extending from the second base portion;
a plurality of second electrical contacts received in the receptacle fitting section of the second insulating case and electrically connectable with the first electrical contacts; and
a guide device extending from the second base portion and forwardly beyond the receptacle fitting section to electrically connect with the shutter member firstly when the plug connector mates with the receptacle connector.

2. The electrical connector assembly according to claim 1, wherein the sliding piece is S-shaped.

3. The electrical connector assembly according to claim 2, wherein the sliding piece of the shutter member slides on the contact pieces of the first shielding cover when the shutter member opens.

4. The electrical connector assembly according to claim 1, wherein the first shielding cover comprises a first grounding piece extending downwards from a lower edge thereof.

5. The electrical connector assembly according to claim 1, wherein the shutter member is made of metal.

6. The electrical connector assembly according to claim 5, wherein the guide device comprises a pair of guide columns, each comprising a groove and the grounding contact secured in the groove, and wherein the grounding contact is formed with a bender secured in the second insulating case.

7. The electrical connector assembly according to claim 6, wherein the shutter member comprises a opening at least one end and a guide piece is formed on one edge of the opening, and wherein when the guide device opens the shutter member, the grounding contact electrically connected with the guide piece of the shutter member.

8. The electrical connector assembly according to claim 1, wherein the shutter member comprises a pair of shutter member halves, each comprising a pivot arm and a pivot hole provided on the pivot arm, and wherein the first insulating case comprises a pair of shafts pivoted with the corresponding pivot holes so that the shutter member rotates about the shafts.

9. The electrical connector assembly according to claim 8, wherein the receptacle connector comprises a spring and each of the pivot arm of the shutter member comprises a locking portion connected with the spring.

10. The electrical connector assembly according to claim 9, wherein the first insulating case comprises a neck portion extending from the first base and a wall portion extending from the neck portion and the shaft is formed on the wall portion.

11. An electrical connector comprising:
an insulating case comprising a fitting section;
a plurality of electrical contacts received in the fitting section of the insulating case;
a conductive shielding cover provided on opposite sides of the insulating case and comprising a contact piece;
a shutter member mounted on the insulating case and movably opening and closing the fitting section of the insulating case, the shutter member comprising a sliding piece slideable on at least one of said insulative case and the contact piece of the shielding cover for stable movement of said shutter member relative to the case.

12. The electrical connector according to claim 1 1, wherein the shutter member is conductive and the sliding piece is slidable on the contact piece of the shielding cover for further electrostatic discharge consideration.

13. The electrical connector according to claim 12, wherein the sliding piece is S-shaped.

14. The electrical connector according to claim 12, wherein the contact piece of the shielding cover is secured into a gap provided on a side wall of the insulating case,

15. The electrical connector according to claim 12, wherein the shutter member comprises an opening and a guide piece formed on one edge of the opening.

16. The electrical connector according to claim 13, wherein a side wall of the insulating case comprises a passage, and wherein the shielding cover comprise an elastic contact piece received in the passage.

17. An electrical connector assembly comprising:
a first connector comprising:
a first insulating case comprising a first base portion having a first fitting section;
a plurality of first electrical contacts received in the first fitting section of the first insulating case;
a shutter member mounted on the first insulating case and movably opening and closing the first fitting section of the first insulating case; and
a second connector comprising:
a second insulating case comprising a second base portion and a second fitting section extending from the second base portion;
a plurality of second electrical contacts received in the second fitting section of the second insulating case and electrically connectable with the first electrical contacts; and
a guide device extending from the second base portion and forwardly beyond the first fitting section with a grounding device to electrically connect with the shutter member firstly when the first connector mates with the second connector.

18. The connector assembly as claimed in claim 17, wherein the shutter member is conductive, and said grounding device engages the shutter member for grounding.

19. The connector assembly as claimed in claim 18, wherein the shutter member defines a guiding piece which engages not only the guiding device for actuating the shutter member to move but also the grounding device for electrostatic discharge.
